(19) United States
(12) Patent Application Publication
(10) Pub. No.: US 2018/0259020 A1
(43) Pub. Date: Sep. 13, 2018

(54) Electric Brake

(71) Applicant: Narr Beteiligungs GmbH, Zell u.A. (DE)

(72) Inventor: Paul Brosowsky, Deggingen (DE)

(21) Appl. No.: 15/915,088

(22) Filed: Mar. 8, 2018

(30) Foreign Application Priority Data
Mar. 8, 2017 (EP) 17159846.9

(51) Int. Cl. F16D 65/16; F16D 55/06; F16D 63/00; F16H 25/20; F16D 65/18; F16D 66/00; F16D 65/22; H02K 7/116; H02K 7/102; H02K 11/21

(52) U.S. Cl. CPC F16D 65/16; F16D 2121/24; F16D 63/004; F16D 63/008; F16H 25/2018; F16D 65/186; F16D 66/00; F16D 65/22; H02K 7/116; H02K 7/102; H02K 11/21; F16H 2025/2046; F16H 2025/2081; F16H 2025/2087; F16D 55/06

(57) ABSTRACT

An electric brake (1) with an electric motor. An electromechanical actuating unit is provided which has a planetary rolling contact gear unit (6) by means of which a rotating movement of the electric motor is translated into an axial movement of an actuating element (7). A brake shoe (8) is coupled as a brake element to the actuating element (7).

### CROSS REFERENCE TO RELATED APPLICATIONS

This application claims the priority of EP 17159846.9 filed on Mar. 8, 2017; this application is incorporated by reference herein in its entirety.

### BACKGROUND

The invention relates to an electric brake.

Such electric brakes are used in machines or systems to brake, grip or hold elements executing rotational or linear movements therein. For example, such electric brakes are used to brake rotating spindles, rotary tables, flywheels, swivel units and the like.

### SUMMARY

The invention relates to an electric brake (1) with an electric motor. An electromechanical actuating unit is provided which has a planetary rolling contact gear unit (6) by means of which a rotating movement of the electric motor is translated into an axial movement of an actuating element (7). A brake shoe (8) is coupled as a brake element to the actuating element (7).

### DETAILED DESCRIPTION

The subject of the invention is to provide an electric brake with a high degree of functionality.

The features of claim 1 have been provided for this purpose. Advantageous embodiments and useful further developments of the invention are described in the dependent claims.

The invention relates to an electric brake with an electric motor. An electromechanical actuating unit is provided that has a planetary rolling contact gear unit by means of which a rotating movement of the electric motor is translated into an axial movement of an actuating element. As a brake element, a brake shoe is coupled to the actuating element.

The electric brake according to the invention is different from known hydraulic or pneumatic systems in that it has a high braking force and requires little installation space. Another advantage of the invention is that the electric-motor-driven actuation of the brake enables a defined braking force initiation and braking force control. Additionally, with the high operating efficiency, the electromechanical brake according to the invention operates much more energy-efficiently than comparable hydraulic systems. Lastly, the planetary rolling contact gear unit used in the brake according to the invention contributes to a considerably longer useful life of the brake compared to systems with other known mechanical gearings.

The electric brake according to the invention is characterized by a high braking force. Furthermore, in the electric brake according to the invention, the electromechanical actuation provides for a zero-backlash absorption of torques. This allows the electric brake according to the invention to be used in various applications, in particular where high precision is required. Examples for this are uses in heavy mechanical engineering or in precision machining systems.

According to a structurally advantageous embodiment, the planetary rolling contact gear unit is integrated in a drive wheel.

The rotational movement of the rotor of the electric motor is transmitted to the drive wheel. By means of the planetary rolling contact gear unit in the drive wheel, the rotational movement of the drive wheel is then translated into a linear movement of the actuating element, which may be formed by either a pull rod or a push rod.

This arrangement is characterized by a compact and simple design.

According to a first variant, the drive wheel is driven directly by the electric motor.

In this case, the electric motor is advantageously formed as a servo motor. This variant is characterized in that it needs particularly few mechanically actuated parts.

According to a second variant, the drive wheel is driven by a gearing downstream of the electric motor which is advantageously formed as a toothed gearing.

In the simplest case, an object can be directly braked by the brake shoe.

Thus, besides the brake shoe, no additional brake elements are needed, which further simplifies the design of the electric brake according to the invention.

According to an advantageous embodiment, the brake shoe actuates a brake member as another brake element. By means of which an object can be braked.

By associating the brake member with the brake shoe, a high braking force may be achieved. Furthermore, by appropriate configurations of the brake member, different types of brakes may be realized.

According to an advantageous embodiment, a braking force adjustment can be carried out via the torque of the electric motor.

The braking force can be very precisely and accurately adjusted via the electric motor. This braking force adjustment allows for flexibly adjusting to different brake processes.

The functionality of the electric brake according to the invention may be further enhanced by providing a sensor system for detecting the braking force. Braking force control can be carried out as a function of the signals from the sensor system.

Such a sensor system may, for example, be formed by a load cell on the pull rod or push rod. Alternatively, a speed sensor system may be provided on rotating machine elements to be braked. By controlling the braking force based on the signals of the respective sensor system, time-based braking processes can be precisely defined and optimized.

According to another advantageous embodiment of the invention, a sensor-based position detection means is provided for detecting the rotation angle position of the rotor, the electric motor or the actuating element, wherein a closing control of brake elements can be carried out based on measurement values of the position detection means.

This monitoring function enhances the operating safety of the electric brake according to the invention.

The electric brake according to the invention may be formed in various embodiments with which braking processes are carried out in different ways.

According to a first embodiment, the electric brake is disk brake.

In this case the brake member is a brake disk.

The brake disk is fixedly attached to the object to be braked such that the brake disk rotates with the object when the brake is not actuated. When the braking process is carried out, the brake disk is braced against a stationary element via the movement of the brake shoe.

The disk brake advantageously has an emergency stop unit by means of which the brake element is mechanically secured when the electric motor is in a de-energized state.

The emergency stop function thus realized significantly enhances the operating safety of the disk brake since a braking effect is also achieved in a de-energized state of the electric motor. The braking effect of the emergency stop unit can be canceled again via suitable actuators such as electromagnets. The emergency stop function is also canceled when the electric motor is supplied with a current again and the electric brake can assume its normal operation.

According to another embodiment, the electric brake is formed as a drum brake.

In this case, the brake member performs a braking motion directed radially outward against the lateral surface of a drum as the object to be braked.

According to another embodiment, the electric brake is formed as a rod brake.

In this case, the brake member performs a braking motion directed radially inward against the outer lateral surface of a rod as the object to be braked.

The brake member is in both cases advantageously formed as a lamellar tensioning or expansion mechanism, which comprises several rotationally symmetric arranged segments flexibly connected to one another.

An axial movement of the actuating element and the brake shoe by means of a cone is advantageously translated into a radial movement of the brake member.

Thus, it is possible to generate the required radial movement of the brake member, in particular the lamellar tensioning or expansion mechanism, with structurally simple means.

### BRIEF DESCRIPTION OF THE DRAWINGS

Below, the invention is explained based on the drawings. They show the following:

FIG. 1: First embodiment of the electric brake according to the invention in the form of a disk brake.

FIG. 2: Second embodiment of the electric brake according to the invention in the form of a drum brake.

FIG. 3: Third embodiment of the electric brake according to the invention in the form of a rod brake.

### DETAILED DESCRIPTION OF THE PREFERRED EMBODIMENTS

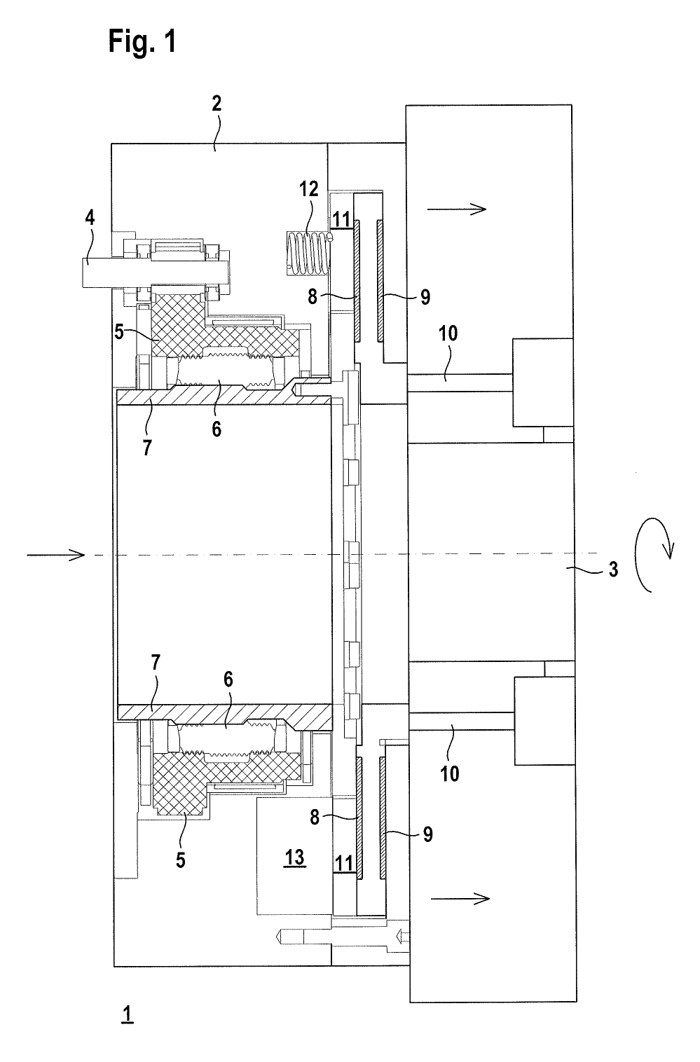

FIG. 1 shows an embodiment of the electric brake 1 according to the invention in the form of a rod brake. Here, the components of the electric brake 1 are integrated in a housing 2. In the present case, the electric brake 1 brakes a machine table 3 connected to the front end of the housing 2. At the back end of the housing 2, a drive shaft 4 exits, forming a connection point for an external electric motor (not shown). The electric motor may be directly connected to the drive shaft 4. In this case, the electric motor is formed as a servo motor. Alternatively, the electric motor may be connected to the drive shaft 4 via a gearing, in particular a toothed gearing.

A planetary rolling contact gear unit 6, which comprises several planet-forming rolling-element bearings distributed in the circumferential direction of the electric brake 1, is integrated in a drive wheel 5. The planetary rolling contact gear unit 6 translates the rotational movement of the drive shaft 4 that is generated by the electric motor into a linear movement of an actuating element 7 formed by a pull rod or a push rod. The planetary rolling contact gear unit 6 displaces the actuating element 7 in the axial direction of the electric brake 1.

A brake shoe 8 as the first brake element is coupled to the actuating element 7. In principle, the brake shoe 8 may form the only brake element and by itself produce a braking force for braking an object. In the present case, a brake member in form of a brake disk 9 as a second brake element is associated with the brake shoe 8. The brake disk 9 is provided with a brake lining on both end faces.

The brake disk 9 is fixedly connected to the machine table 3 via connecting elements 10 such that the brake disk 9 rotates with the machine table 3 when the electric brake 1 is not actuated.

To actuate the electric brake 1, the brake shoe 8 is displaced by the actuating element 7 such that the brake shoe 8 is being pressed against the brake disk 9. This causes the brake disk 9 to be braced between the brake shoe 8 and the housing 2, thus braking the machine table 3. The movements of the individual components are identified with arrows in FIG. 1.

The amount of braking force can be defined via the amount of torque of the electric motor.

A sensor system, such as a load cell on the actuating element 7 or a speed sensor system on the machine table 3, enables a controlled braking of the machine table 3 based on the sensor signals.

Furthermore, sensor-based position detection means for detecting the angle positions of the electric motor or a position measurement of the actuating element 7 allow for detecting wear on the contacts at the braking points of the brake disk 9.

The disk brake according to FIG. 1 also has an emergency stop function. The emergency stop function is executed by means of a retaining plate 11 and its associated compression springs 12. In a de-energized state of the electric motor, for example, in case of an emergency stop, the brake disk 9 is clamped with these elements, whereby the machine component brakes or is secured even in a de-energized state. The emergency retainer can be disengaged via electromagnets 13. For this operation, the electromagnets 13 move the retaining plate 11 against the spring force of the compression springs 12.

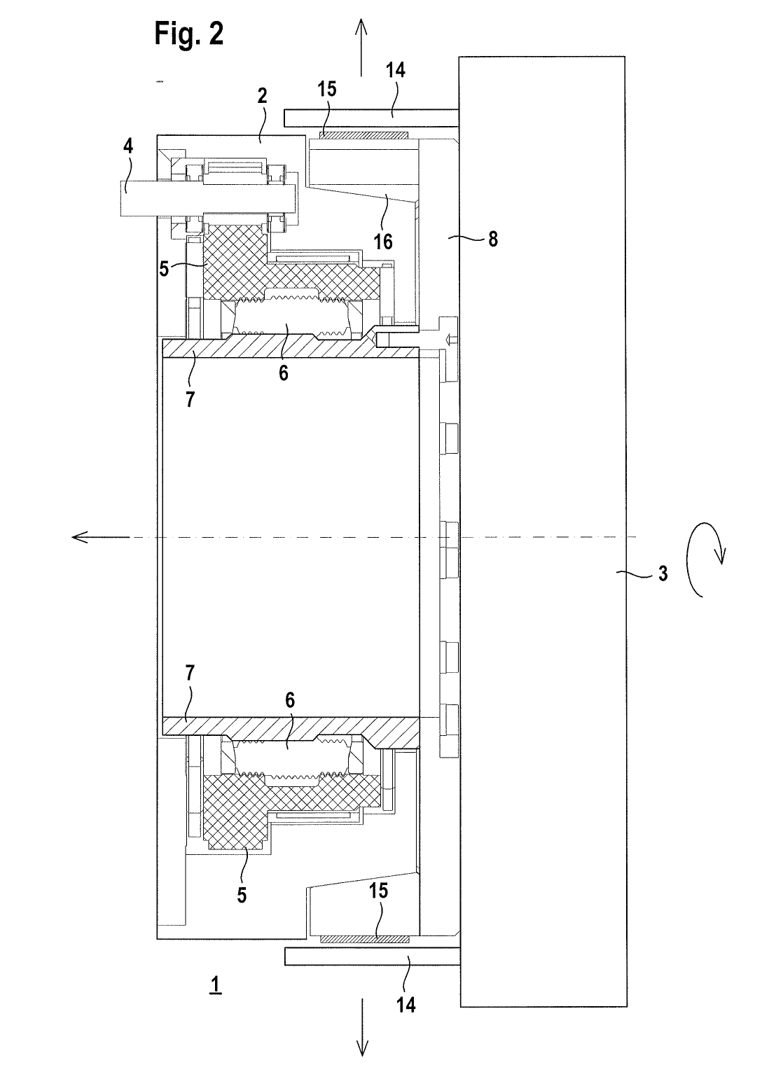

FIG. 2 shows an embodiment of the electric brake 1 according to the invention in the form of a drum brake.

The design of the drum brake matches the disk brake according to FIG. 1 in that in a housing 2 a drive shaft 4, a planetary rolling contact gear unit 6 integrated in a drive wheel 5 and an actuating element 7, to which a brake shoe 8 is coupled, are provided.

In further accordance with the embodiment according to FIG. 1, a braking force adjustment via the electric motor or, if a pertinent sensor system is provided, a control of the braking process may be performed. Likewise, a wear monitoring of the brake elements by means of suitable position detection means may be provided.

In the drum brake according to FIG. 2, the object is again a machine table 3. However, contrary to the embodiment according to FIG. 1, in this case the machine table 3 is not fixedly connected to the brake member. Instead, a hollow cylindrical component connects to the machine table 3 forming the drum 14 of the drum brake.

In FIG. 2, the operating principle of the brake is again illustrated with arrows indicating the movements of the individual components.

The actuating element 7 again displaces a brake shoe 8 in axial direction, wherein in the present case the brake shoe 8 is located on the front surface of the housing 2 facing the machine table 3. The brake shoe 8 actuates a brake member formed, in the present case, by a lamellar tensioning or expansion mechanism 15 comprising an arrangement of identically formed segments that adjoin one another in the circumferential direction of the electric brake 1 and interconnect via flexible elements.

The lamellar tensioning or expansion mechanism 15 is associated with a cone 16 forming an angle translation and also serves to increase the braking force. To actuate the electric brake 1, the brake shoe 8 is displaced by means of the actuating element 7. This causes lamellar tensioning or expansion mechanism 15 to slide on the inclined surface of the cone 16 such that the mechanism is moved radially outwardly and thus is pressed with its lateral surfaces, on which brake linings are provided, against the inner wall of the drum 14 to brake the machine table 3.

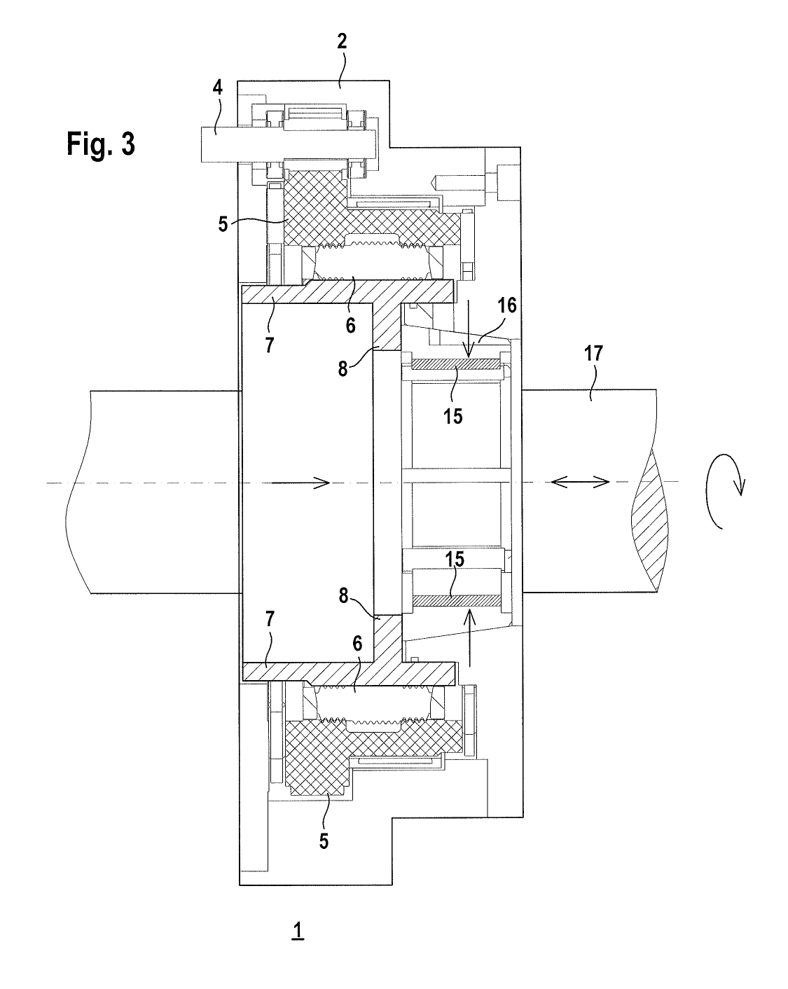

FIG. 3 shows an embodiment of the electric brake 1 according to the invention in the form of a rod brake.

The design of the rod brake matches the disk brake according to FIG. 1 in the respect that a drive shaft 4, a planetary rolling contact gear unit 6 integrated in a drive wheel 5 and an actuating element 7, to which a brake shoe 8 is coupled, are provided in a housing 2.

Also in accordance with the embodiment according to FIG. 1, a braking force adjustment via the electric motor or, if a pertinent sensor system is provided, a control of the braking process may be performed. Likewise, a wear monitoring of the brake elements by means of suitable position detection means may be provided.

In the rod brake according to FIG. 3, the object to be braked is formed by a rod 17 that extends in the axial direction of the electric brake 1 and is enclosed by the components thereof.

In accordance with the embodiment according to FIG. 2, a brake member in form of a lamellar tensioning or expansion mechanism 15 is actuated by the brake shoe 8, which is axially displaceable by means of the actuating element 7. A cone 16 is associated again with the lamellar tensioning or expansion mechanism 15, by means of which the axial movement of the brake shoe 8 is translated into a radial movement of the lamellar tensioning or expansion mechanism 15.

Contrary to the embodiment according to FIG. 2, in the embodiment according to FIG. 3, the lamellar tensioning or expansion mechanism 15 is moved radially inward by the movement of the brake shoe 8 and the angle translation of the cone 16 such that the mechanism's lateral surfaces, on which brake linings are provided, are pressed radially inward against the rod 17 to brake the same.

In the embodiment of FIG. 3, the movements of individual components of brake 1 are illustrated by arrows, too.

### LIST OF REFERENCE NUMERALS

(1) Electric brake

(2) Housing

(3) Machine table

(4) Drive shaft

(5) Drive wheel

(6) Planetary rolling contact gear unit

(7) Actuating element

(8) Brake shoe

(9) Brake disk

(10) Connecting element

(11) Retaining plate

(12) Compression spring

(13) Electromagnet

(14) Drum

(15) Lamellar tensioning or expansion mechanism

(16) Cone

(17) Rod

1. An electric brake (1) having an electric motor, characterized in that an electromechanical actuating unit is provided which has a planetary rolling contact gear unit (6) by means of which a rotational movement of the electric motor is translated into an axial movement of an actuating element (7), wherein a brake shoe (8) is coupled to the actuating element (7) as a brake element.

2. The electric brake according to claim 1, characterized in that the planetary rolling contact gear unit (6) is integrated in a drive wheel (5).

3. The electric brake according to claim 2, characterized in that the drive wheel (5) is driven directly by the electric motor.

4. The electric brake according to claim 2, characterized in that the drive wheel (5) is driven by a gearing downstream of the electric motor.

5. The electric brake according to claim 4, characterized in that the gearing is a toothed gearing.

6. The electric brake according to claim 1, characterized in that the actuating element (7) is a pull rod.

7. The electric brake according to claim 1, characterized in that an object may be braked by the brake shoe (8) directly.

8. The electric brake according to claim 1, characterized in that a brake member, as a further brake element, is actuated by the brake shoe (8) by means of which an object can be braked.

9. The electric brake according to claim 1, characterized in that a braking force adjustment can be performed via the torque of the electric motor.

10. The electric brake according to claim 1, characterized in that a sensor system is provided for braking force detection.

11. The electric brake according to claim 10, characterized in that a braking force control can be carried out as a function of the signals of the sensor system.

12. The electric brake according to claim 1, characterized in that position detection means for detecting the position of the electric motor or the actuating element (7) is provided, wherein a closing control of brake elements can be carried out based on measurement values of the position detection means.

13. The electric brake according to claim 1, characterized in that the same is a disk brake.

14. The electric brake according to claim 13, characterized in that the brake member is a brake disk (9).

15. The electric brake according to claim 13, characterized in that the same has an emergency stop unit, by means of which the brake element is mechanically secured when the electric motor is in a de-energized state.

16. The electric brake according to claim 1, characterized in that the same is a drum brake or a rod brake.

17. The electric brake according to claim 16, characterized in that the brake member is a lamellar tensioning or expansion mechanism (15).

18. The electric brake according to claim 17, characterized in that an axial movement of the actuating element (7) and the brake shoe (8) is translated by means of a cone (16) into a radial movement of the brake member.
